(19) United States
(12) Patent Application Publication
(10) Pub. No.: US 2007/0019752 A1
(43) Pub. Date: Jan. 25, 2007

(54) Decoders using fixed noise variance and methods of using the same

(75) Inventor: Yong-Woon Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/483,986

(22) Filed: Jul. 10, 2006

(30) Foreign Application Priority Data
Jul. 19, 2005 (KR) 10-2005-0065148

(51) Int. Cl. H04K 1/10; H04L 27/06

(52) U.S. Cl. 375/260; 375/340

(57) ABSTRACT

Decoders are provided including a data input unit configured to receive and store data. A noise variance judging unit is configured to select a fixed noise variance from a lookup table including at least one predetermined fixed noise variance. A log-likelihood ratio (LLR) calculating unit is configured to calculate an LLR based on the data and the selected fixed noise variance. A decoding unit is configured to perform a decode operation using the LLR to provide decoded data. Related methods are also provided herein.

### CLAIM OF PRIORITY

This application is related to and claims priority from Korean Patent Application No. No. 2005-65148 filed on Jul. 19, 2005, in the Korean Intellectual Property Office, the disclosure of which is hereby incorporated herein by reference as if set forth in its entirety.

### FIELD OF THE INVENTION

The present invention relates to decoders and related methods, and more particularly, decoders using fixed noise variance and related methods.

### BACKGROUND OF THE INVENTION

Various types of data, such as video, audio, text, and the like are, in general, represented by binary data that may be referred to as bit(s). The binary data may be stored in a storage system or may be sent through a communication system. When this binary data is stored in the storage system or transmitted through the communication system, a bit error may occur. For example, a “0” may be changed to “1,” a “1” may be changed to “0,” or the bit value is “1” or “0” may be indeterminate. In order to reduce the amount of bit errors that may occur on noisy channels, channel coding may be performed on the binary data and the channel-coded data may be transmitted via the channel.

Referring now to FIG. 1, a flow diagram illustrating a transmitting stage 107, a channel 155, and a receiving stage 197 of a conventional communication system will be discussed. As illustrated in FIG. 1, the flow of the transmission stage 107 includes source data 100, channel coding 110, constellation mapping 120, modulation 130, filtering 140 and AFE 150. The transmitting stage 107 leads into the channel 155 which may or may not include noise 160. The flow of the receiving stage 197 includes analog front end (AFE) 170, filtering 175, demodulation 180, constellation demapping 185, channel decoding 190 and restored source data 195. Various types of channels 155, such as wire channels, wireless channels, storage media channels and the like, may exist between the transmitting stage 107 and the receiving stage 197. Data transmitted over the channels 155 may not be correctly received due to noise 160 that may occur in the channels. In order to reduce the influence of the noise, the transmitting stage 107 typically adds redundant data to source data 105 through the channel coding 110 before modulation 130 of the transmitting stage, and then the receiving stage 197 performs a channel decoding 190 on the received data, in which the noise is included, by using the added redundant data to restore the source data 197.

Channel coding algorithms may be divided into two major types, block codes and convolutional codes. The block codes include Reed-Solomon code (RSC), Bose-Chaudhuri-Hocquenghem (BCH) code, block turbo code (BTC), low-density parity-check (LDPC) code, and the like. Of these, the low-density parity check (LDPC) code typically has excellent error-correction capability. Methods and systems for routing a decoder of LDPC are discussed in, for example, in Korean Patent Publication No. 2004-030085. The LDPC code is one of the block codes, which are defined by a parity-check matrix, and is characterized by a significantly smaller number of “1”s than that of “0”s in the parity-check matrix. In order to perform the decoding on the LDPC code, the receiving stage divides a received codeword “r” by a noise variance σ² to calculate a log-likelihood ratio (LLR). The calculated LLR is input to an LDPC decoder. In other words, the input LLR is obtained by calculating

$$\frac{r}{{σ}^{2}} ,$$

and a desired decoding performance may be obtained only by using the correct noise variance whenever the codeword is received. Furthermore, in order to obtain the desired decoding performance, the noise variance may be changed through a channel estimation according to noise variation of the channel.

### SUMMARY OF THE INVENTION

Some embodiments of the present invention provide decoders including a data input unit configured to receive and store data. A noise variance judging unit is configured to select a fixed noise variance from a lookup table including at least one predetermined fixed noise variance. A log-likelihood ratio (LLR) calculating unit is configured to calculate an LLR based on the data and the selected fixed noise variance. A decoding unit is configured to perform a decode operation using the LLR to provide decoded data.

In further embodiments of the present invention, the predetermined fixed noise variances may be predetermined based on a type of constellation and the selected fixed noise variance may correspond to input constellation information. One or more fixed noise variances may be predetermined for each type of constellation. Each of the fixed noise variances may be obtained based on a value within an error waterfall region of a graph that shows a relationship between a signal-to-noise ratio (SNR) of the data and a frame error rate (FER) of the data corresponding to the type of constellation with respect to a modulation method. The SNR of the data may be more than a predetermined threshold value in the error waterfall region.

In still further embodiments of the present invention, the noise variance judging unit may be configured to include the lookup table.

In some embodiments of the present invention, the LLR calculating unit may be configured to calculate the LLR by dividing the data by the selected fixed noise variance. In further embodiments of the present invention, the LLR calculating unit may be configured to calculate the LLR by multiplying the data by a reciprocal of the selected fixed noise variance.

Although decoders are specifically discussed above, embodiments of the present invention also include related methods of decoding data.

### BRIEF DESCRIPTION OF THE DRAWINGS

FIG. 1 is a flow block diagram illustrating a transmitting stage, a channel and a receiving stage of a conventional communication system.

FIG. 2 is a graph illustrating a relationship between a signal-to-noise ratio (SNR) and a frame error rate (FER) of received data using quadrature phase-shift keying (QPSK) according to some embodiments of the present invention.

FIG. 3 is a table illustrating noise variances corresponding to the types of constellation information according to some embodiments of the present invention.

FIG. 4 is a block diagram illustrating a decoder using a fixed noise variance according to some embodiments of the present invention.

FIG. 5 is a flow diagram illustrating a decoding method using the fixed noise variance according to some embodiments of the present invention.

FIG. 6 is a graph illustrating a relationship between an SNR and a frame error rate (FER) of low-density parity-check (LDPC) codes different from each other using quadrature phase-shift keying (QPSK) according to some embodiments of the present invention.

FIG. 7 is a table illustrating fixed noise variances depending on constellation information and channel state information according to some embodiments of the present invention.

FIG. 8 is a constellation diagram for obtaining a noise variance of a received signal according to some embodiments of the present invention.

FIG. 9 is a block diagram illustrating a decoder using the fixed noise variance according to some embodiments of the present invention.

FIG. 10 is a flow diagram illustrating a decoding method using the fixed noise variance according to some embodiments of the present invention.

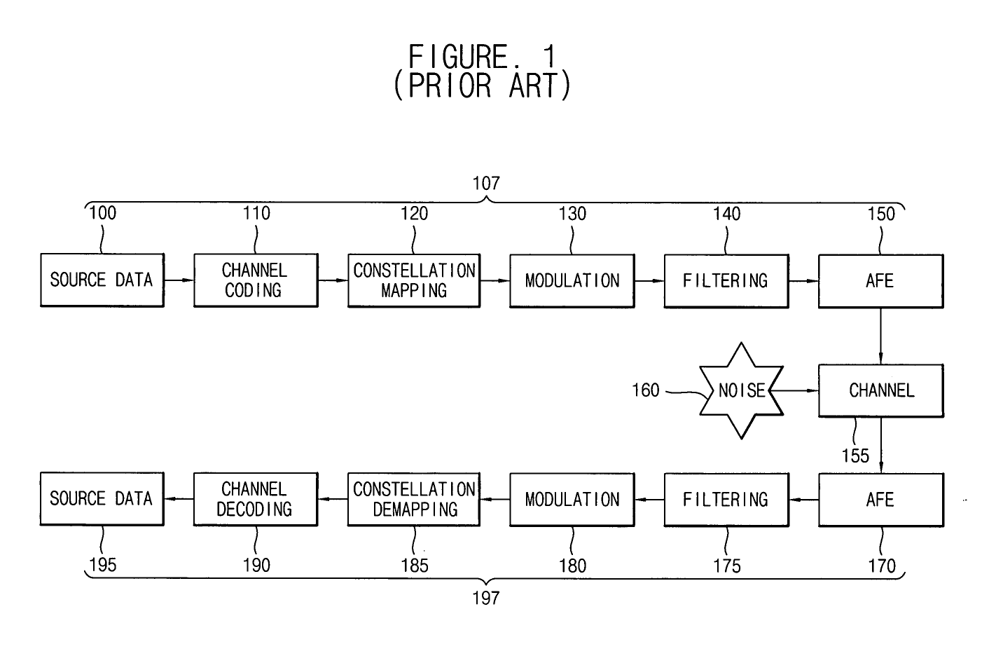

### DETAILED DESCRIPTION OF EMBODIMENTS OF THE PRESENT INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that the some embodiments of the present invention are described herein with respect to flowchart diagrams. It should also be noted that, in some alternative implementations, the operations noted in the flowcharts may occur out of the order noted in the figures. For example, two blocks shown in succession may, in fact, be executed substantially concurrently, or the blocks may sometimes be executed in the reverse order.

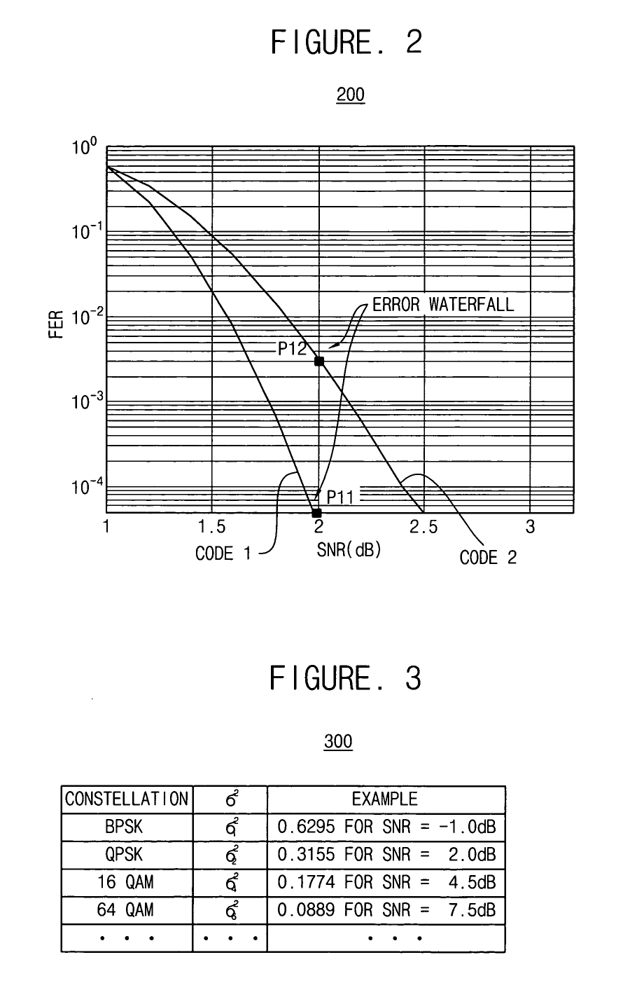

Some embodiments of the present invention will be discussed with respect to FIGS. 2 through 10 below. Referring first to FIG. 2, a graph 200 illustrating a relationship between a signal-to-noise ratio (SNR) and a frame error rate (FER) of received data using quadrature phase-shift keying (QPSK) according to some embodiments of the present invention will be discussed. A fixed noise variance may be calculated at any point within an error waterfall section (or region) of an SNR of received data using QPSK according to some embodiments of the present invention. A data transmitting/receiving system may use various data modulation/demodulation methods, such as binary phase-shift keying (BPSK), QPSK, 16-state quadrature amplitude modulation (1 6-QAM), 64-state quadrature amplitude modulation (64-QAM), and the like, without departing from the scope of the present invention.

As illustrated in FIG. 2, an error waterfall phenomenon of the QPSK occurs at an SNR region neighboring 2.0 dB. In other words, assuming that a code rate is 1/2 in the SNR region neighboring 2.0 dB, the result of the QPSK for each low-density parity-check (LDPC) code has an error value of approximately 0. In the SNR region less than 1.7 dB, most or all error values of the QPSK for the respective LDPC codes may be increased. Consequently, an error waterfall region corresponds to a region in which the SNR is greater than 2.0 dB.

The error waterfall phenomenon in the specified region also occurs in the cases where the BPSK and the QAM are used. Accordingly, the fixed noise variance a σ² for decoding the received data may be calculated from any point within the error waterfall region. For example, referring to FIG. 2, any point, for example, P11, within the error waterfall region using an LDPC code 1, and any point, for example, P12, within the error waterfall region using an LDPC code 2, may have the SNR of approximately 2.0 dB. Accordingly, a reciprocal value (i.e., 0.3155) of a power value corresponding to 2.0 dB may be stored in a noise variance storing table as a fixed noise variance. A noise variance storing table 300 will be discussed below with respect to FIG. 3.

Referring now to FIG. 3, a noise variance table 300 that stores noise variances corresponding to the types of constellation information according to some embodiments of the present invention will be discussed. The constellation information used to transmit and receive the data is related to a data modulation technique. The constellation information may include information on the modulation techniques, such as BPSK, QPSK, 16-QAM, 64-QAM, and the like.

Referring again to FIG. 3, the fixed noise variance is determined by the respective constellation information. For example, when the constellation information represents the BPSK, the fixed noise variance σ₁² may be determined as 0.6295 for SNR=−1.0 dB, which is any point within the error waterfall region. When the constellation information represents the QPSK, the fixed noise variance σ₂² may be determined as 0.3155 for SNR=2.0 dB, which is any point within the error waterfall region. When the constellation information represents the 16-QAM, the fixed noise variance σ₄² may be determined as 0.1774 for SNR=4.5 dB, which is any point within the error waterfall region. When the constellation information represents the 64-QAM, the fixed noise variance σ₆² may be determined as 0.0889 for SNR=7.5 dB, which is any point within the error waterfall region. When the constellation information represents 128-QAM or 256-QAM, the corresponding fixed noise variance may be calculated at any SNR point within the error waterfall region using the above-described method, to be stored in the noise variance storing table 300. Furthermore, the table 300 may also store a reciprocal value 1/σ² of the predetermined noise variance σ² corresponding to the respective modulation techniques (or corresponding to the type of constellation information) may be stored in the noise variance storing table 300.

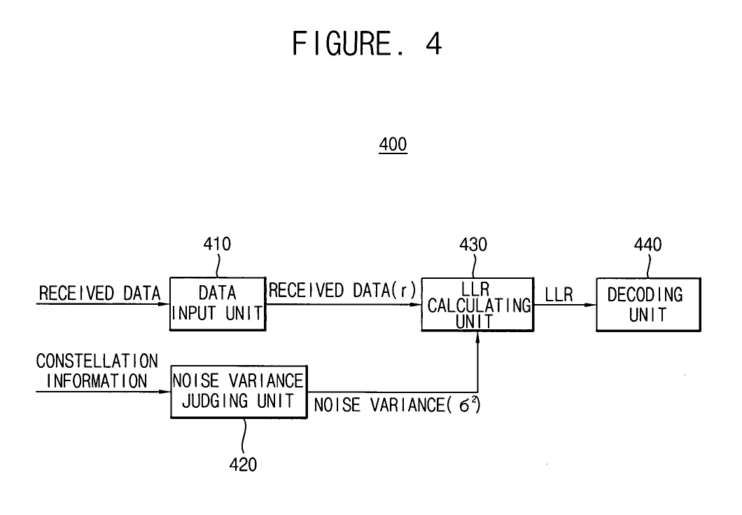

According some embodiments of the present invention, with respect to the respective modulation techniques, one noise variance σ² or 1/σ² corresponding to any one of the SNRs within the error waterfall region is calculated in advance, and then the calculated noise variance is stored in a lookup table. Operations of decoders using the storage table 300 according to some embodiments of the present invention will be discussed with respect to FIG. 4.

Referring now to FIG. 4, a block diagram illustrating a decoder using a fixed noise variance according to some embodiments of the present invention will be discussed. As illustrated in FIG. 4, the decoder 400 includes a data input unit 410, a noise variance judging unit 420, an LLR calculating unit 430, and a decoding unit 440. Data “r” received at the decoder 400 may include channel noise, which is added to the data while the data is transmitted from a transmitting stage via the channel, and is stored in the data input unit 410.

The noise variance judging unit 420 may be configured to receive constellation information according to various modulation techniques. The constellation information has information on the modulation techniques, such as the BPSK, the QPSK, the 16-QAM, the 64-QAM, and the like. The noise variance judging unit 420 is further configured to access the noise variance storing table in which the noise variances are stored as discussed above with respect to FIG. 3, and output a corresponding noise variance that is selected based on the constellation information. For example, referring back to FIG. 3, when the constellation information is QPSK, the corresponding fixed noise variance σ₂² in the noise variance storing table 300 is selected, and thus the corresponding fixed noise variance (i.e., 0.3155) is output.

The LLR calculating unit 430 may be configured to receive the data “r” from the data input unit 410 and the noise variance σ² from the noise variance judging unit 420, and calculate

$$\frac{r}{{σ}^{2}}$$

to output the resultant value, i.e., the LLR. The LLR calculating unit 430 may be configured to divide the received data “r” by the noise variance σ² to obtain the LLR. In some embodiments of the present invention, the LLR calculating unit 430 may also be configured to multiply the received data “r” by 1/σ² to obtain the LLR, in which 1/σ² is calculated and stored in advance. The decoding unit 440 is configured to decode using the LLR to provide decoded data.

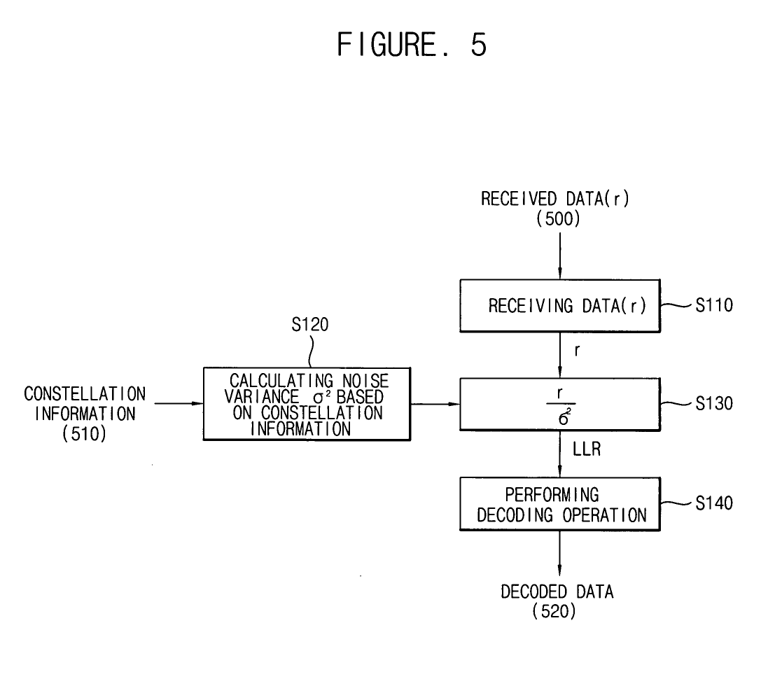

Referring now to FIG. 5, a flow diagram illustrating a decoding method using the fixed noise variance according to some embodiments of the present invention will be discussed. As illustrated in FIG. 5, the decoding method includes receiving and storing the data r 500 (step S110). Constellation information 510 that may be predetermined between a transmitter and a receiver is also received, and the noise variance σ² is calculated based on the constellation information 510 (step S120). In some embodiments of the present invention, a reciprocal 1/σ² of the noise variance σ² may be calculated.

The constellation information 510 may include information on the modulation techniques, such as the BPSK, the QPSK, the 16-QAM, the 64-QAM, and the like. As discussed above with respect to FIG. 3, according to the respective modulation techniques, the fixed noise variance σ² or 1/σ² is calculated in advance at any point within the error waterfall region, and the calculated noise variance is stored in the lookup table. When the constellation information is received, the fixed noise variance σ² or 1/σ² corresponding to the received constellation information is selectively output from the lookup table.

The LLR, i.e.,

$$\frac{r}{{σ}^{2}} ,$$

is calculated using the received data r 500 and the noise variance σ² (step S130). The LLR may be obtained by dividing the received data r 500 by the noise variance σ². In some embodiments of the present invention, the LLR may also be obtained by multiplying the received data by 1/σ². A data decoding operation is performed by using the LLR, i.e.,

$$\frac{r}{{σ}^{2}}$$

(step S140) to provide decoded data 520.

Referring now to FIG. 6, a graph 600 illustrating a relationship between an SNR and a frame error rate (FER) of low-density parity-check (LDPC) codes different from each other, using quadrature phase-shift keying (QPSK) according to some embodiments of the present invention will be discussed. An SNR of received data is divided into discrete regions of LDPC codes different from each other, using QPSK according to some embodiments of the present invention. The fixed noise variance may be calculated at any point within the discrete regions.

A data transmitting/receiving system may include various data modulation/demodulation methods, such as the BPSK, the QPSK, the 16-QAM, the 64-QAM, and the like. The modulation technique used to produce the information illustrated in the graph 600 of FIG. 6 is the QPSK technique. As illustrated in FIG. 6, the signal-to-noise ratio region of the received signal may be divided into one or more regions and the noise variance may be calculated at any point within the respective divided regions, and thus errors of the fixed noise variance may be reduced.

For example, referring to FIG. 6, regardless of the code rate in QPSK for the respective LDPC codes 1, 2 and 3, an SNR region between 0 to 1.6 dB may be set to a region 0, an SNR region between 1.6 to 1.8 dB may be set to a region 1, and an SNR region over 1.8 dB may be set to a region 2.

The number of regions may be 1, 2 or more than 4 according to the modulation technique or a channel environment. In the respective regions, the decibel value at a point P21 of 1.5 dB within the region 0, the decibel value at a point P22 of 1.7 dB within the region 1, and the decibel value at a point P23 of 2.0 dB within the region 2 are converted into a power value. A noise variance is obtained by calculating the reciprocal of the converted power value.

Likewise, according to the respective modulation techniques, the SNR of the received signal is divided into regions, the fixed noise variance is calculated at any point within the divided regions, and the obtained noise variance is stored in the lookup table.

For example, using the 16-QAM technique, 0 to 3.0 dB may be divided into the region 0, 3.0 to 4.0 dB into the region 1, and 4.0 or more dB into the region 2. The fixed noise variance is calculated at the respective regions (0, 1, 2), and the obtained fixed noise variance is stored in the noise variance table.

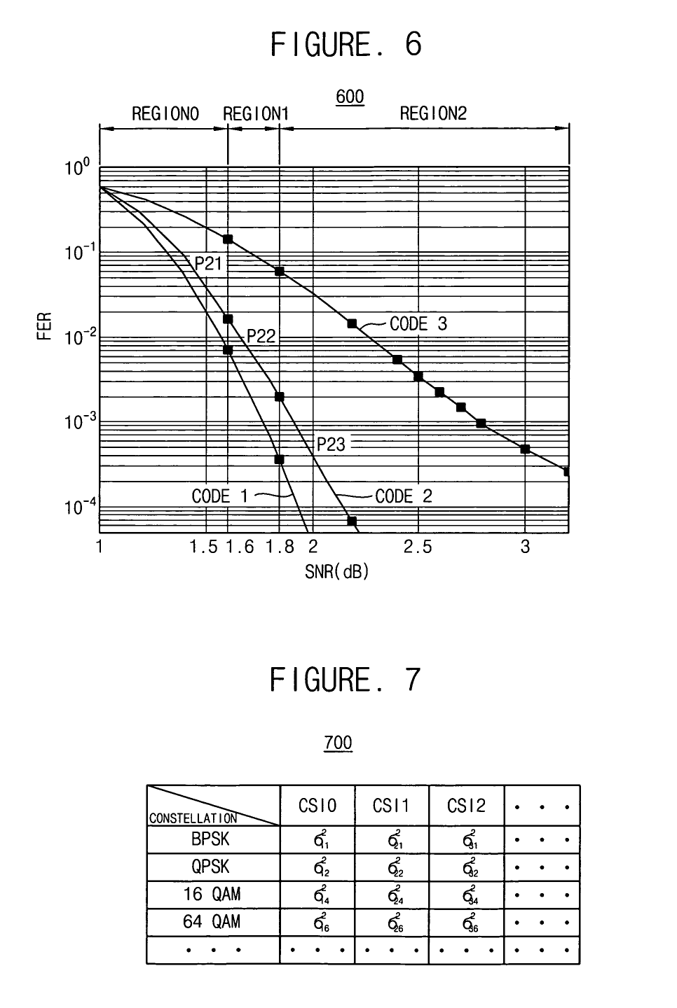

Referring now to FIG. 7, a table 700 including fixed noise variances depending on constellation information and channel state information according some embodiments of the present invention will be discussed. The channel state information is determined by measuring the SNR of the received data at the receiver stage. For example, referring to FIG. 6, using QPSK, when the SNR is between 0 to 1.6 dB (region 0), when the SNR is between 1.6 to 1.8 dB (region 1), and when the SNR is over 1.8 dB (region 2), the channel state information is respectively determined as CSI0, CSI1 and CSI2. Additionally, using 16-QAM, when the SNR of the data is 0 to 3.0 dB (region 0), 3.0 to 4.0 dB (region 1), and 4.0 or more dB (region 2), the channel state information is determined as CSI0, CSI1 and CSI2, respectively.

Consequently, the receiver stores, in advance, the noise variances into the noise variance storage table (i.e., lookup table 700) of FIG. 7, based on the constellation information and the channel state information of the data to be received. The channel state information is decided and the constellation information is received. The fixed noise variance σ² or 1/σ² of the received data is output from the noise variance storage table. For example, when the channel state information is determined as CS1 based on the channel state information of the received data and the constellation information of the received data is QPSK, the noise variance σ₂₂² or 1/σ₂₂² is output.

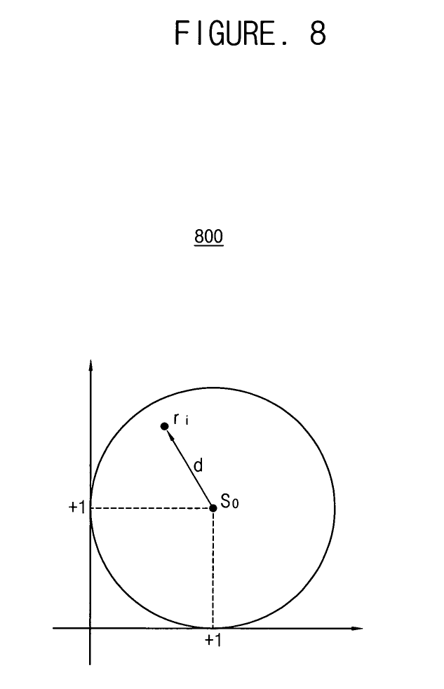

Referring now to FIG. 8, a constellation diagram 800 for obtaining a noise variance of a received signal according to some embodiments of the present invention will be discussed. The noise variance of the received signal may be calculated by Equation 1.

$${σ}^{2} = \frac{{\sum }_{i = 1}^{N} {( {r}_{i} - {S}_{0} )}^{2}}{N} \qquad ( Equation 1 )$$

where “N” denotes the number of the data samples to be used for obtaining the noise variance, “S0” denotes a constellation point, and “ri” denotes the received signal.

When the SNR region is divided into two regions, for example, an SNR region less than 1.8 dB and an SNR region no less than 1.8 dB, the channel state information CSI may be decided by Equations 2 and 3, respectively.

$$\begin{matrix}CSI = 0 if SNR ( 1.8 dB ) = \frac{1}{{σ}^{2}} < {CSI}_{threshold} & ( Equation 2 ) \\ CSI = 0 if SNR ( 1.8 dB ) = \frac{1}{{σ}^{2}} \geq {CSI}_{threshold} & ( Equation 3 )\end{matrix}$$

When the SNR region is divided into three regions, for example, an SNR region less than 1.5 dB, an SNR region no less than 1.5 dB and less than 1.8 dB, and an SNR region no less than 1.8 dB, the channel state information (CSI) may be decided by Equations 4, 5 and 6, respectively.

$$\begin{matrix}\begin{matrix}CSI = 0 if SNR ( 1.5 dB ) \\ = \frac{1}{{σ}^{2}} < {CSI}_{threshold\_ 0}\end{matrix} & ( Equation 4 ) \\ \begin{matrix}CSI = 1 if SNR ( 1.5 dB ) \\ = {CSI}_{threshold\_ 0} <= \frac{1}{{σ}^{2}} < {CSI}_{treshold\_ 1} \\ = SNR ( 1.8 dB )\end{matrix} & ( Equation 5 ) \\ \begin{matrix}CSI = 2 if SNR ( 1.8 dB ) \\ = {CSI}_{threshold\_ 1} \leq \frac{1}{{σ}^{2}} \\ = SNR ( 1.8 dB )\end{matrix} & ( Equation 6 )\end{matrix}$$

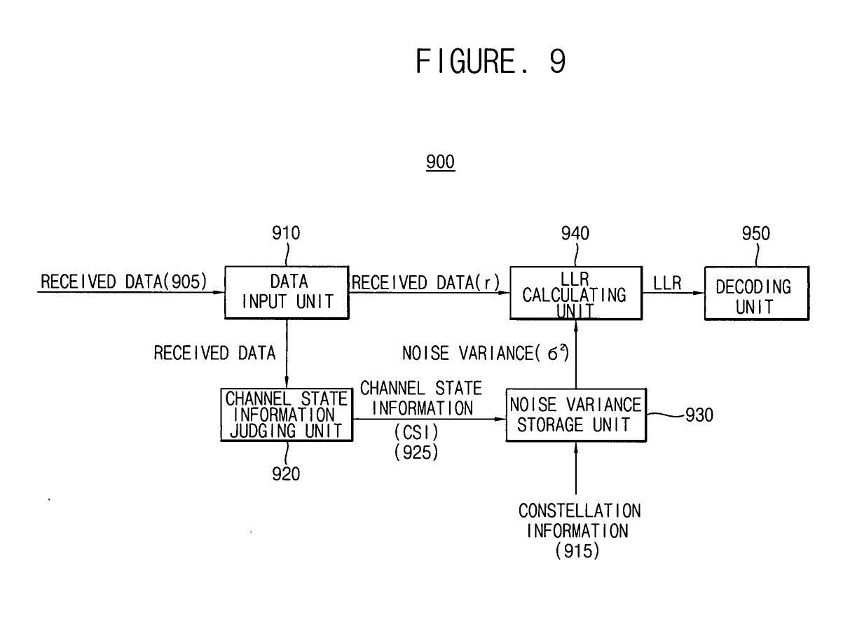

Referring now to FIG. 9, a block diagram illustrating a decoder 900 using the fixed noise variance according to some embodiments of the present invention will be discussed. As illustrated in FIG. 9, a decoder 900 includes a data input unit 910, a channel state information judging unit 920, a noise variance judging unit 930, an LLR calculating unit 940, and a decoding unit 950. The decoder 900 is configured to receive data “r” 905. The received data “r” 905 includes data transmitted from a transmitting stage and may include channel noise that is added into the data while the data is transmitted via a channel, and stored in the data input unit 910. For example, the data input unit 910 may be, for example, a buffer.

The channel state information judging unit 920 is configured to extract channel state information from the received data “r” 905 output from the data input unit 910. For example, referring back to FIG. 6, using QPSK, when the SNR of the received data r is between 0 to 1.6 dB (region 0), when the SNR is between 1.6 to 1.8 dB (region 1), and when the SNR is over 1.8 dB (region 2), the channel state information is judged to be CSI0, CSI1 and CSI2, respectively. Furthermore, using 16-QAM, when the SNR of the received data r is 0 to 3.0 dB (region 0), 3.0 to 4.0 dB (region 1), and 4.0 or more dB (region 2), the channel state information is judged to be CSI0, CSI1 and CSI2, respectively, in the same manner.

The extracted channel state information is output to the noise variance judging unit 930. The noise variance judging unit 930 includes a noise variance table (not shown) in which at least one fixed noise variance is stored as discussed above with respect to FIG. 7. The noise variance judging unit 930 is configured to select a fixed noise variance from the noise variance table (not shown) using the channel state information 925 and the constellation information 915 of the received data “r” 905.

For example, referring back to FIG. 7, when the constellation information 925 is QPSK and the received data r 905 is the SNR of 2.0 dB, the channel state information judging unit 920 judges the channel state information 925 of the received data as CSI2, the noise variance judging unit 920 receives the channel state information CSI2 and the constellation information 915 QPSK, and selects a fixed noise variance σ₂₂ ² or a reciprocal of the fixed noise variance 1/σ₂₂² from the noise variance table (not shown).

The LLR calculating unit 940 receives the received data “r” 905 from the data input unit 90 and the noise variance σ² or the reciprocal of the fixed noise variance 1/σ² obtained by the noise variance judging unit 930. The LLR calculating unit 940 calculates an LLR, i.e.,

$$\frac{r}{{σ}^{2}} ,$$

by dividing the received data “r” 905 by the noise variance σ². The decoding unit 950 performs a decoding operation using the received LLR, i.e.

$$\frac{r}{{σ}^{2}} .$$

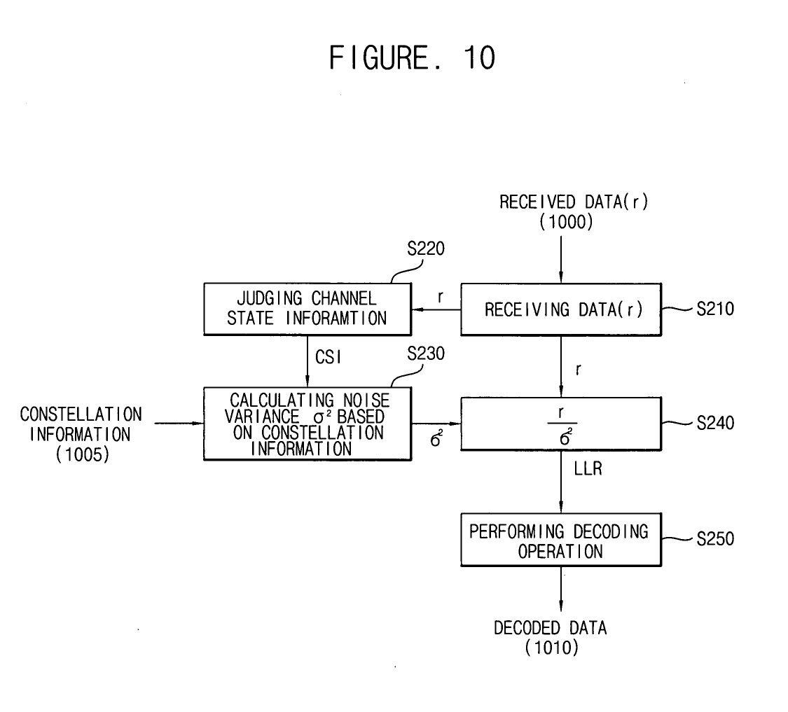

Referring now to FIG. 10, a flow diagram illustrating a decoding method using a fixed noise variance according to some embodiments of the present invention will be discussed. As illustrated in FIG. 10, the decoding method stores the received data “r” 1000 (step S210). The channel state information of the received data is judged (step S220). For example, referring back to FIG. 6, using QPSK, when the SNR of the received data is between 0 to 1.6 dB (region 0), when the SNR is between 1.6 to 1.8 dB (region 1), and when the SNR is over 1.8 dB (region 2), the channel state information is judged to be CSI0, CSI1 and CSI2, respectively. Furthermore, using 16-QAM, when the SNR of the received data is 0 to 3.0 dB (region 0), 3.0 to 4.0 dB (region 1), and 4.0 or more dB (region 2), the channel state information is judged to be CSI0, CSI1 and CSI2, respectively, in the same manner.

The constellation information 1005 includes information on the modulation techniques, such as the BPSK, the QPSK, the 16-QAM, the 64-QAM, and the like. As discussed above with respect to FIG. 3, according to the respective modulation techniques, the fixed noise variance σ² or 1/σ² is calculated in advance at any point within the error waterfall region, and the calculated noise variance is stored in the storage table, i.e., the lookup table. When the constellation information 1005 is received, the fixed noise variance σ² or 1/σ² corresponding to the received constellation information is selectively output. The LLR, i.e.,

$$\frac{r}{{σ}^{2}} ,$$

may be obtained based on the stored data r and the noise variance σ² or 1/σ² (step S240). In some embodiments of the present invention, the LLR may be obtained by dividing the received data r by the noise variance σ². The LLR may be also obtained by multiplying the received data by the noise variance 1/σ². The data decoding is performed using LLR (step S250) to provide decoded data 1010.

As discussed briefly above with respect to FIGS. 2 through 10, a fixed noise variance corresponding to input constellation information is selected based on at least one fixed noise variance, which is predetermined according to the type of constellation information, and an LLR is calculated based on the data and the selected fixed noise variance. Thus, according to some embodiments of the present invention, desired decoding performance may be obtained without calculating the noise variance for every received data code.

Furthermore, as discussed above, the channel state information is extracted from the received data, a fixed noise variance corresponding to the extracted channel state information, and constellation information is selected based on at least one fixed noise variance, which is predetermined according to the type of extracted channel state information and the constellation information, and an LLR is calculated based on the received data and the selected fixed noise variance corresponding to the extracted channel state information and the constellation information. Accordingly, the decoders and the decoding methods according to some embodiments of the present invention can reduce the errors of the fixed noise variance because it is not required to change the noise variance due to a change of the channel noise by channel estimation whenever the received data code is received, and the calculation burden during decoding of the received data may be reduced. In addition, desired decoding performance may be obtained without calculating the noise variance for every received data code.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A decoder comprising:
a data input unit configured to receive and store data;
a noise variance judging unit configured to select a fixed noise variance from a lookup table including at least one predetermined fixed noise variance;
a log-likelihood ratio (LLR) calculating unit configured to calculate an LLR based on the data and the selected fixed noise variance; and
a decoding unit configured to perform a decode operation using the LLR to provide decoded data.

2. The decoder of claim 1, wherein the at least one predetermined fixed noise variance is predetermined based on a type of constellation and wherein the selected fixed noise variance corresponds to input constellation information.

3. The decoder of claim 2, wherein the at least one fixed noise variance is predetermined for each type of constellation.

4. The decoder of claim 3, wherein each of the fixed noise variances is obtained based on a value within an error waterfall region of a graph that shows a relationship between a signal-to-noise ratio (SNR) of the data and a frame error rate (FER) of the data corresponding to the type of constellation with respect to a modulation method, the SNR of the data being more than a predetermined threshold value in the error waterfall region.

5. The decoder of claim 4, wherein the noise variance judging unit is configured to include the lookup table.

6. The decoder of claim 1, wherein the LLR calculating unit is configured to calculate the LLR by dividing the data by the selected fixed noise variance.

7. The decoder of claim 1, wherein the LLR calculating unit is configured to calculate the LLR by multiplying the data by a reciprocal of the selected fixed noise variance.

8. A decoder comprising:
a data input unit configured to receive and store data;
a channel state information judging unit configured to extract channel state information from the data;
a noise variance judging unit configured to select a fixed noise variance from at least one fixed noise variance that is predetermined based on a types of channel state and types of constellation, the selected fixed noise variance corresponding to the extracted channel state information and input constellation information;
an LLR calculating unit configured to calculate an LLR based on the data and the selected fixed noise variance; and
a decoding unit configured to perform a decoding operation using the LLR to provided decoded data.

9. The decoder of claim 8, wherein at least three fixed noise variances corresponding to respective types of channel state are predetermined for each of the types of constellation.

10. The decoder of claim 9, wherein each of the fixed noise variances is obtained based on a value within a corresponding region of at least one region of a graph that shows a relationship between a signal-to-noise ratio (SNR) of the data and a frame error rate (FER) of the data corresponding to the type of constellation with respect to a modulation method, an SNR of the graph being divided into the one or more regions according to the types of channel state.

11. The decoder of claim 8, wherein the types of channel state, the types of constellation, and the fixed noise variances that is predetermined according to the types of channel state and the types of constellation are stored in a lookup table.

12. The decoder of claim 8, wherein the types of channel state, the types of constellation, and reciprocals of the fixed noise variances that is predetermined according to the types of channel state and the types of constellation are stored in a lookup table.

13. The decoder of claim 11, wherein the noise variance judging unit is configured to include the lookup table.

14. The decoder of claim 8, wherein the LLR calculating unit is configured to calculate the LLR by dividing the data by the selected fixed noise variance.

15. The decoder of claim 9, wherein the LLR calculating unit is configured to calculate the LLR by multiplying the data by a reciprocal of the selected fixed noise variance.

16. A method of decoding data comprising:
receiving data;
selecting a fixed noise variance from at least one fixed noise variances that is predetermined according to types of constellation, the selected fixed noise variance corresponding to input constellation information;
calculating an LLR based on the received data and the selected fixed noise variance; and
performing a decoding operation using the LLR to provide decoded data.

17. The method of claim 16, wherein each of the fixed noise variances is obtained based on a value within an error waterfall region of a graph that shows a relationship between a signal-to-noise ratio (SNR) of the data and a frame error rate (FER) of the data corresponding to the type of constellation with respect to a modulation method, the SNR of the data being more than a predetermined threshold value in the error waterfall region.

18. The method of claim 16, wherein the types of constellation and the fixed noise variances that is predetermined according to the types of constellation are stored in a lookup table.

19. The method of claim 16, wherein the types of constellation and reciprocals of the fixed noise variances that is predetermined according to the types of constellation are stored in the lookup table.

20. The method of claim 16, wherein the LLR is calculated by dividing the data by the selected fixed noise variance.

21. The method of claim 16, wherein the LLR is calculated by multiplying the data by a reciprocal of the selected fixed noise variance.

22. A method of decoding data comprising:
receiving data;
extracting channel state information from the received data;
selecting a fixed noise variance from at least one fixed noise variance that is predetermined according to types of channel state and types of constellation, the selected fixed noise variance corresponding to the extracted channel state information and input constellation information;
calculating an LLR based on the data and the selected fixed noise variance; and
performing a decoding operation using the LLR to provide decoded data

23. The method of claim 22, wherein at least three fixed noise variances corresponding to the respective types of channel state are predetermined for respective types of constellation.

24. The method of claim 22, wherein the fixed noise variance is obtained based on a value within at least one region of a graph that shows a relationship between a signal-to-noise ratio (SNR) of the data and a frame error rate (FER) of the data in a modulation method corresponding to the constellation information, and an SNR axis of the graph is divided into the at least one region according to the extracted channel state information.

25. The method of claim 22, wherein the types of channel state, the types of constellation, and the fixed noise variances that is predetermined according to the types of channel state and the types of constellation are stored in a lookup table.

26. The method of claim 22, wherein the types of channel state, the types of constellation, and reciprocals of the fixed noise variances that is predetermined according to the types of channel state and the types of constellation are stored in a lookup table.

27. The method of claim 22, wherein the LLR is calculated by dividing the data by the selected fixed noise variance.

28. The method of claim 22, wherein the LLR is calculated by multiplying the data by a reciprocal of the selected fixed noise variance.
